(19) United States
(12) Patent Application Publication
(10) Pub. No.: US 2025/0171250 A1
(43) Pub. Date: May 29, 2025

(54) SUCTION COLLECTION SYSTEM

(71) Applicants: NGK INSULATORS, LTD., Nagoya-Shi (JP); NGK KILNTECH, CORPORATION, Nagoya-Shi (JP)

(72) Inventors: Takanori ISONO, Nagoya-Shi (JP); Masashi TANAMURA, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/675,457

(22) Filed: May 28, 2024

(30) Foreign Application Priority Data
Nov. 28, 2023 (JP) 2023-200735

(51) Int. Cl. B65G 47/91; B28B 11/24; B28B 17/04; B65G 47/24; B65G 47/90; B65G 59/02; B65G 59/12; F27B 9/24

(52) U.S. Cl. CPC B65G 47/91; B28B 17/04; B65G 47/24; B65G 47/901; B65G 59/02; B65G 59/12; F27B 9/24; B28B 11/243; B65G 2814/031

(57) ABSTRACT

A suction collection system may include: a heat treatment chamber; a suction chamber disposed downstream of an exit of the heat treatment chamber; a suction nozzle disposed in the suction chamber and configured to suction and collect an object; a first partition disposed between the heat treatment chamber and the suction chamber and configured to perform switching between a communicating state in which the heat treatment chamber and the suction chamber communicate and a non-communicating state in which the heat treatment chamber and the suction chamber do not communicate; a gas replacement chamber disposed downstream of the suction chamber; and a second partition disposed between the suction chamber and the gas replacement chamber and configured to perform switching between a communicating state in which the suction chamber and the gas replacement chamber communicate and a non-communicating state in which the suction chamber and the gas replacement do not communicate.

### REFERENCE TO RELATED APPLICATIONS

This application claims priority to Japanese Patent Application No. 2023-200735, filed on Nov. 28, 2023, the entire contents of which are hereby incorporated by reference into the present application.

### TECHNICAL FIELD

The disclosure herewith relates to a suction collection system.

### BACKGROUND ART

Japanese Patent Application Publication No. 2011-236463 describes a suction collection system. The suction collection system includes a heat treatment chamber, a suction collection chamber located at the exit of the heat treatment chamber, and a suction nozzle that suctions objects in saggars in the suction collection chamber.

### SUMMARY

In the suction collection system described above, the suction collection chamber is connected to the heat treatment chamber. In this condition, when the suction nozzle suctions the object in the saggars, the heat treatment chamber is depressurized. This disturbs gas flow inside the heat treatment chamber.

The present disclosure discloses a technique that can suppress gas flow disturbance in a heat treatment chamber.

In the first aspect of the art disclosed herein, a suction collection system may comprise: a conveying device configured to convey saggars in a conveying direction; a heat treatment chamber including an entrance and an exit and inside which the saggars are conveyed from the entrance toward the exit; a suction chamber disposed downstream of the exit and through which the saggars conveyed out of the exit move; a suction nozzle disposed in the suction chamber and configured to suction and collect an object in each of the saggars; a first partition disposed between the heat treatment chamber and the suction chamber and configured to perform switching between a communicating state in which the heat treatment chamber and the suction chamber communicate and a non-communicating state in which the heat treatment chamber and the suction chamber do not communicate; a gas replacement chamber disposed downstream of the suction chamber and through which the saggars conveyed out of the suction chamber move though the gas replacement chamber; and a second partition disposed between the suction chamber and the gas replacement chamber and configured to perform switching between a communicating state in which the suction chamber and the gas replacement chamber communicate and a non-communicating state in which the suction chamber and the gas replacement chamber do not communicate.

According to the above configuration, when the first partition performs switching to the non-communicating state in which the heat treatment chamber and the suction chamber do not communicate, communication between the heat treatment chamber and the suction chamber is cut off. In this state, even when the suction nozzle suctions the objects in the saggars in the suction chamber, depressurization in the heat treatment chamber is suppressed. Consequently, gas flow disturbance in the heat treatment chamber can be suppressed.

### BRIEF DESCRIPTION OF DRAWINGS

FIG. 1 illustrates a schematic view of a suction collection system of an embodiment viewed from the right side.

FIG. 2 illustrates a schematic view of the suction collection system of the embodiment viewed from the top.

FIG. 3 illustrates a schematic diagram of an entrance-side gas replacement part of the suction collection system of the embodiment when a first partition is in a communicating position.

FIG. 4 illustrates a schematic view of the entrance-side gas replacement part of the suction collection system of the embodiment when a second partition is in a communicating position.

FIG. 5 illustrates a schematic view of an unstacking part in the suction collection system of the embodiment.

FIG. 6 illustrates a schematic view of the unstacking part in the suction collection system of the embodiment when a lifting device body is moving upward.

FIG. 7 illustrates a schematic view of the unstacking part in the suction collection system of the embodiment when the lifting device body is moving downward with an upper saggar clamped by a clamping device body.

FIG. 8 illustrates a schematic view of the unstacking part in the suction collection system of the embodiment when the lifting device body is moving upward.

FIG. 9 illustrates a schematic view of a suction collection part in the suction collection system of the embodiment when the first partition is in a communicating position.

FIG. 10 illustrates a schematic view of a suction collection device of the embodiment.

FIG. 11 illustrates a schematic view of the suction collection part in the suction collection system of the embodiment.

FIG. 12 illustrates a schematic view of an exit-side gas replacement part in the suction collection system of the embodiment when the second partition is in a communicating position.

FIG. 13 illustrates a schematic view of the exit-side gas replacement part in the suction collection system of the embodiment when a third partition is in a communicating position.

FIG. 14 illustrates a schematic view of the unstacking part in the suction collection system of the embodiment when the lifting device body is moving downward.

FIG. 15 illustrates a schematic view of the suction collection part in the suction collection system of the embodiment.

FIG. 16 illustrates a schematic view of the suction collection part in the suction collection system of the embodiment.

FIG. 17 illustrates a schematic view of the suction collection part in the suction collection system of the embodiment.

FIG. 18 illustrates a schematic view of the suction collection part in the suction collection system of the embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved suction collection systems, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In the second aspect of the art disclosed herein, in the above-mentioned first aspect, the suction collection system may further comprise: a posture adjusting chamber disposed between the heat treatment chamber and the suction chamber and through which the saggars conveyed out of the exit move; and a posture adjusting device configured to adjust postures of the saggars in the posture adjusting chamber. The first partition may be disposed between the posture adjusting chamber and the suction chamber. According to the above configuration, the suction nozzle suctions the objects in the saggars with the postures of the saggars adjusted. Consequently, the objects can be efficiently suctioned. Further, by virtue of the first partition performing switching to the non-communicating state in which the heat treatment chamber and the suction chamber do not communicate, gas flow disturbance in the heat treatment chamber can be suppressed even in the configuration where the posture adjusting chamber is located between the heat treatment chamber and the suction chamber.

In the third aspect of the art disclosed herein, in the above-mentioned second aspect, the conveying device may be configured to convey the saggars in the conveying direction in a state where the saggars are stacked. The suction collection system may further comprise: an unstacking chamber disposed between the posture adjusting chamber and the suction chamber and through which the saggars conveyed out of the posture adjusting chamber move; and an unstacking device configured to unstack the stacked saggars so that the saggars are not stacked in the posture adjusting chamber. According to the above configuration, gas flow disturbance in the heat treatment chamber can be suppressed even in the configuration where a plurality of saggars is conveyed in a stacked state.

In the fourth aspect of the art disclosed herein, in the above-mentioned third aspect, the unstacking device may comprise: a clamping device body configured to clamp the saggar; and a clamping actuator configured to operate the clamping device body. The clamping actuator may be disposed outside of the unstacking chamber. According to the above configuration, when the clamping actuator operates the clamping device body, wear dust may be generated from the clamping actuator. Since the clamping actuator is located outside of the unstacking chamber, it is possible to suppress the wear powder from mixing with the objects in the saggars.

In the fifth aspect of the art disclosed herein, in the above-mentioned third or fourth aspect, the unstacking device may comprise: a lifting device body configured to lift the stacked saggars; a lifting actuator configured to operate the lifting device body; and a clamping device body configured to clamp one of the stacked saggars lifted by the lifting device body. The lifting actuator may be disposed outside of the unstacking chamber. According to the configuration, when the lifting actuator operates the lifting device body, wear dust may be generated from the lifting actuator. Since the lifting actuator is located outside of the unstacking chamber, it is possible to suppress the wear dust from mixing with the object in the saggars.

In the sixth aspect of the art disclosed herein, in any one of the above-mentioned third to fifth aspects, the first partition may be disposed between the unstacking chamber and the suction chamber. When the suction chamber and the heat treatment chamber communicate via the posture adjusting chamber and the unstacking chamber, the heat treatment chamber is depressurized when the suction nozzle suctions the objects in the saggars in the suction chamber. According to the above configuration, depressurization in the heat treatment chamber is suppressed even when the suction nozzle suctions the objects in the saggars in the suction chamber. This can suppress gas flow disturbance in the heat treatment chamber.

In the seventh aspect of the art disclosed herein, in any one of the above-mentioned first to sixth aspects, the suction nozzle may be configured not to move in a left-right direction perpendicular to the conveying direction. The suction collection system may further comprise a saggar moving device configured to move each of the saggars in the left-right direction relative to the suction nozzle when the suction nozzle collects the object in each of the saggars. According to the above configuration, it is easier to secure sealing performance in the suction chamber as compared to the configuration in which the suction nozzle is moved in the left-right direction relative to the saggars, and the configuration of the suction collection system can be suppressed from becoming complicated.

In the eighth aspect of the art disclosed herein, in the above-mentioned seventh aspect, the suction collection system may further comprise a lifting device configured to lift the saggar in the suction chamber. The saggar moving device may be configured to move the saggar in the left-right direction relative to the suction nozzle in a state where the saggar is lifted by the lifting device. According to the above configuration, it is possible to suppress the saggar from moving in the conveying direction when the object in the saggar is being collected.

In the nineth aspect of the art disclosed herein, in any one of the above-mentioned first to eighth aspects, the suction collection system may further comprise a first actuator disposed outside of the suction chamber and configured to operate the first partition. According to the above configuration, when the first actuator operates the first partition, wear dust may be generated from the first actuator. Since the first actuator is disposed outside of the suction chamber, it is possible to suppress the wear dust from mixing with the object in the saggars.

In the tenth aspect of the art disclosed herein, in any one of the above-mentioned first to nineth aspects, the suction collection system may further comprise a second actuator disposed outside of the gas replacement chamber and configured to operate the second partition. According to the above configuration, when the second actuator operates the second partition, wear dust may be generated from the second actuator. Since the second actuator is disposed outside of the suction chamber, it is possible to suppress the wear dust from mixing with the object in the saggars.

### EMBODIMENTS

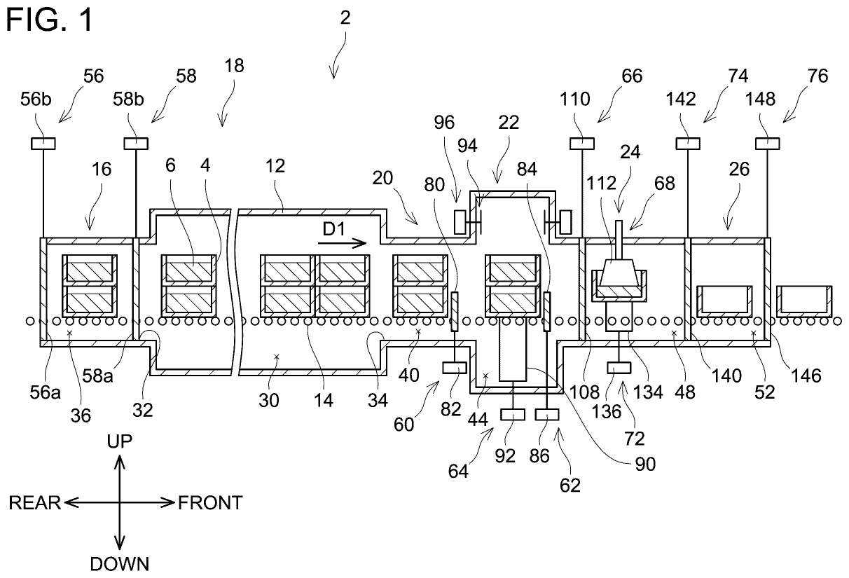

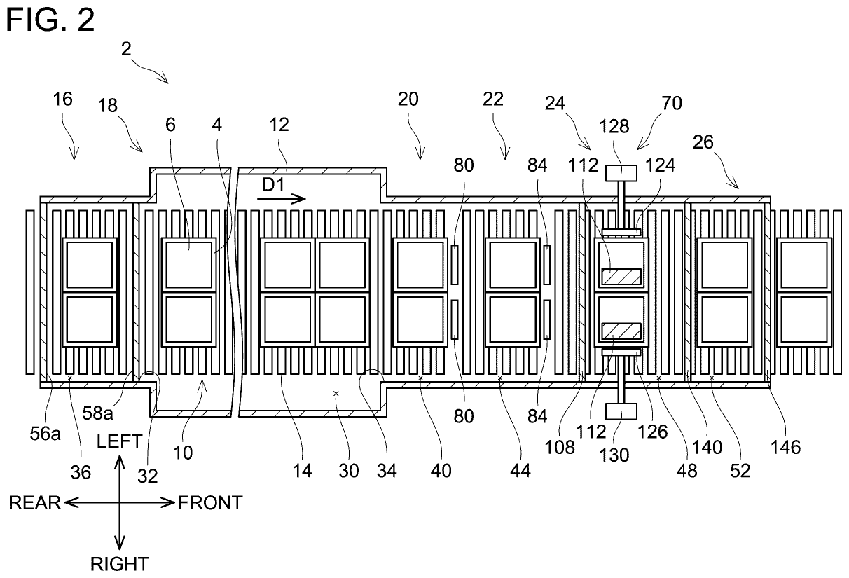

As illustrated in FIGS. 1 and 2, a suction collection system 2 comprises a conveying device 10 and a furnace body 12.

The conveying device 10 is located both inside and outside of a furnace body 12. The conveying device 10 comprises a plurality of rollers 14, each end of which is rotatably supported. As the plurality of rollers 14 rotates, saggars 4 on the rollers 14 are conveyed in a conveying direction D1 inside the furnace body 12. Hereafter, the conveying direction D1 is called a forward direction, the opposite of the forward direction is called a rearward direction, the direction orthogonal in the horizontal plane to the forward direction is called a left-right direction, and the direction orthogonal to the forward and left-right directions is called an upward direction. In the present embodiment, two saggars 4 are placed on the plurality of rollers 14 with these saggars 4 stacked in the up-down direction, and conveyed into the furnace body 12 (see FIG. 1). Pairs of saggars 4 stacked in the up-down direction are placed on the plurality of rollers 14 with the pairs of saggars arranged side by side in the left-right direction (see FIG. 2). On the other hand, as illustrated in FIG. 1, the pair of saggars 4 stacked in the up-down direction are brought into a state not stacked in the up-down direction, and then conveyed out of the furnace body 12.

The furnace body 12 comprises an entrance-side gas replacement part 16, a heat treatment part 18, a posture adjusting part 20, an unstacking part 22, a suction collection part 24, and an exit-side gas replacement part 26. The entrance-side gas replacement part 16, the heat treatment part 18, the posture adjusting part 20, the unstacking part 22, the suction collection part 24, and the exit-side gas replacement part 26 are arranged in this order in the conveying direction D1.

The entrance-side gas replacement part 16 includes an entrance-side gas replacement chamber 36 therein. The entrance-side gas replacement part 16 replaces the gas in the entrance-side gas replacement chamber 36 from air to ambient gas or replaces the gas in the entrance-side gas replacement chamber 36 from ambient gas to air. The entrance-side gas replacement chamber 36 is connected to the outside of the furnace body 12. The saggars 4 are conveyed into the entrance-side gas replacement chamber 36 from outside the furnace body 12 and move through the entrance-side gas replacement chamber 36.

The heat treatment part 18 includes a heat treatment chamber 30 therein. The heat treatment chamber 30 is filled with ambient gas. The ambient gas is, for example, nitrogen gas. The heat treatment chamber 30 is located downstream of the entrance-side gas replacement chamber 36 in the conveying direction D1. The heat treatment chamber 30 fires, i.e., performs heat treatment on the objects 6 in the saggars 4 by using heater(s) (not illustrated). The objects 6 are, for example, materials for ceramic capacitors or positive or negative electrode materials for lithium-ion batteries. The heat treatment chamber 30 includes an entrance 32 located at one end in the front-rear direction and an exit 34 located at the other end in the front-rear direction. The heat treatment chamber 30 is connected to the entrance-side gas replacement chamber 36 through the entrance 32. The saggars 4 which have been conveyed out of the entrance-side gas replacement chamber 36 move through the heat treatment chamber 30. The plurality of saggars 4 moves in the heat treatment chamber 30 in the conveying direction D1 from the entrance 32 to the exit 34 with the pairs of stacked saggars 4 arranged side by side in the left-right direction. In the heat treatment chamber 30, a gas supply pipe (not illustrated) that supplies ambient gas into the heat treatment chamber 30 is provided. By supplying the ambient gas from the gas supply pipe to the heat treatment chamber 30, the gas generated when the objects 6 are subjected to heat treatment is purged from the surroundings of the objects 6. By purging the gas generated from the objects 6, efficiency of the firing of the objects 6 is promoted. In the heat treatment chamber 30, an exhaust port to exhaust the gas in the heat treatment chamber 30 is provided. Therefore, the ambient gas supplied into the heat treatment chamber 30 from the gas supply pipe flows through the heat treatment chamber 30, and is exhausted out of the heat treatment chamber 30 from the exhaust port. The gas flows through the heat treatment chamber 30 without stagnation, by which firing of the object 6 can be performed efficiently.

The posture adjusting part 20 includes a posture adjusting chamber 40 therein. The posture adjusting chamber 40 is filled with ambient gas. The posture adjusting chamber 40 is located downstream of the heat treatment chamber 30 in the conveying direction D1. The posture adjusting chamber 40 is connected to the heat treatment chamber 30 via the exit 34. The saggars 4 which have been conveyed out of the exit 34 move through the posture adjusting chamber 40.

The unstacking part 22 includes an unstacking chamber 44 therein. The unstacking chamber 44 is filled with ambient gas. The unstacking chamber 44 is located downstream of the posture adjusting chamber 40 in the conveying direction D1. Therefore, the posture adjusting chamber 40 is located between the heat treatment chamber 30 and the unstacking chamber 44. The unstacking chamber 44 is connected to the heat treatment chamber 30 through the posture adjusting chamber 40. The saggars 4 which have been conveyed out of the posture adjusting chamber 40 are conveyed through the unstacking chamber 44.

The suction collection part 24 includes a suction chamber 48 therein. The suction chamber 48 is filled with ambient gas. The suction chamber 48 is located downstream of the unstacking chamber 44 in the conveying direction D1. Therefore, the unstacking chamber 44 is located between the posture adjusting chamber 40 and the suction chamber 48. The suction chamber 48 is connected to the heat treatment chamber 30 through the unstacking chamber 44 and the posture adjusting chamber 40. The saggars 4 which have been conveyed out of the unstacking chamber 44 are conveyed through the suction chamber 48.

The exit-side gas replacement part 26 includes an exit-side gas replacement chamber 52 therein. The exit-side gas replacement part 26 replaces the gas in the exit-side gas replacement chamber 52 from ambient gas to air, or replaces the gas in the exit-side gas replacement chamber 52 from air to ambient gas. The exit-side gas replacement chamber 52 is located downstream of the suction chamber 48 in the conveying direction D1. Therefore, the suction chamber 48 is located between the unstacking chamber 44 and the exit-side gas replacement chamber 52. The exit-side gas replacement chamber 52 is connected to the heat treatment chamber 30 through the suction chamber 48, the unstacking chamber 44, and the posture adjusting chamber 40. The saggars 4 which have been conveyed out of the suction chamber 48 are conveyed through the exit-side gas replacement chamber 52. The downstream end of the exit-side gas replacement chamber 52 in the conveying direction D1 is connected to the outside of the furnace body 12. The saggars 4 are conveyed out of the downstream end of the exit-side gas replacement chamber 52 in the conveying direction D1 to the outside of the furnace body 12.

The suction collection system 2 comprises a primary partition device 56, a secondary partition device 58, a posture adjusting device 60, a stopper device 62, an unstacking device 64, a first partition device 66, a suction collection device 68, a saggar moving device 70 (see FIG. 2), a lifting device 72, a second partition device 74, a third partition device 76.

As illustrated in FIG. 1, the primary partition device 56 comprises a primary partition 56a and a primary actuator 56b.

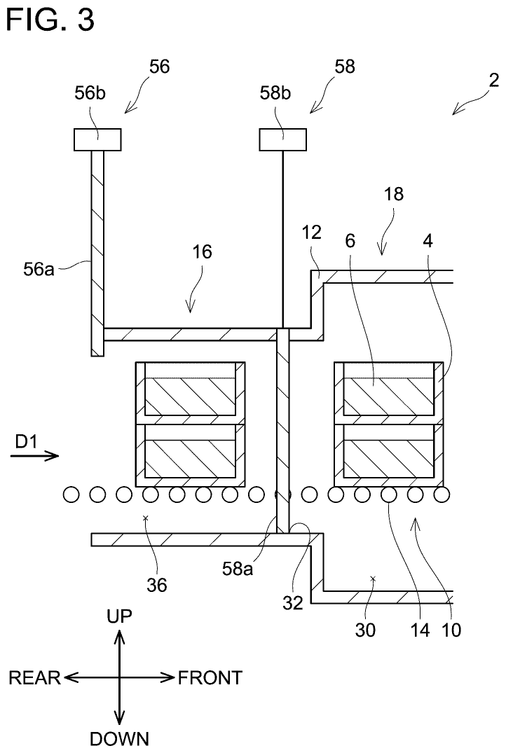

The primary partition 56a is located between (at the boundary of) the space outside the furnace body 12 and the entrance-side gas replacement chamber 36. The primary actuator 56b is located outside of the furnace body 12. Therefore, even when wear dust is generated from the primary actuator 56b due to the operation of the primary actuator 56b, the wear dust is suppressed from entering the entrance-side gas replacement chamber 36. The primary actuator 56b operates the primary partition 56a. The primary partition 56a switches its position between a non-communicating position and a communicating position by the operation of the primary actuator 56b. When the primary partition 56a is in the non-communicating position, it blocks the communication between the entrance-side gas replacement chamber 36 and the space outside the furnace body 12. In this state, the entrance-side gas replacement chamber 36 and the space outside the furnace body 12 do not communicate. As illustrated in FIG. 3, when the primary partition 56a is in the communicating position, the lower end of the primary partition 56a is positioned above the upper end of the upper saggar 4 on the rollers 14. In this state, the entrance-side gas replacement chamber 36 and the space outside of the furnace body 12 communicate. Therefore, the primary partition 56a switches its position between the non-communicating position and the communicating position to perform switching between the non-communicating state in which the entrance-side gas replacement chamber 36 and the space outside of the furnace body 12 do not communicate and the communicating state in which the entrance-side gas replacement chamber 36 and the space outside the furnace body 12 communicate.

As illustrated in FIG. 1, the secondary partition device 58 comprises a secondary partition 58a and a secondary actuator 58b.

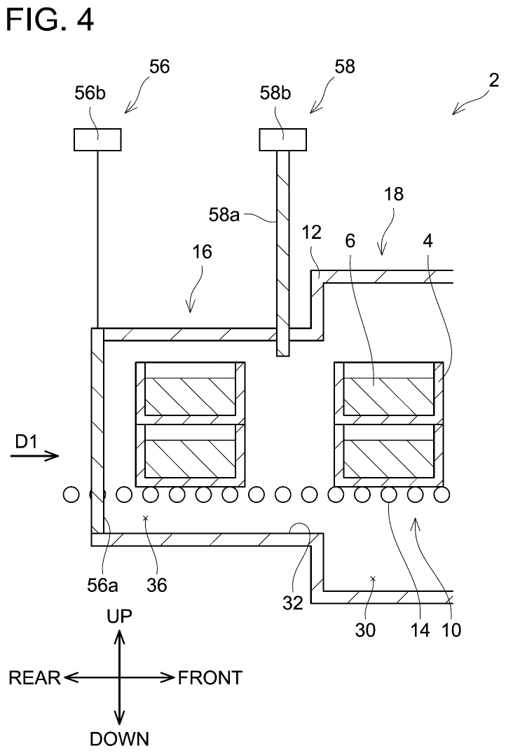

The secondary partition 58a is located inside the furnace body 12. The secondary partition 58a is located between (at the boundary of) the entrance-side gas replacement chamber 36 and the heat treatment chamber 30. The secondary actuator 58b is disposed outside of the furnace body 12. Therefore, even when wear dust is generated from the secondary actuator 58b due to the operation of the secondary actuator 58b, the wear dust is suppressed from entering the entrance-side gas replacement chamber 36 and the heat treatment chamber 30. The secondary actuator 58b operates the secondary partition 58a. The secondary partition 58a switches its position between a non-communicating position and a communicating position by the operation of the secondary actuator 58b. When the secondary partition 58a is in the non-communicating position, it blocks the communication between the entrance-side gas replacement chamber 36 and the heat treatment chamber 30. In this state, the entrance-side gas replacement chamber 36 and the heat treatment chamber 30 do not communicate. As illustrated in FIG. 4, when the secondary partition 58a is in the communicating position, the lower end of the secondary partition 58a is positioned above the upper end of the upper saggar 4 on the rollers 14. In this state, the entrance-side gas replacement chamber 36 and the heat treatment chamber 30 communicate. Therefore, by switching its position between the non-communicating position and the communicating position, the secondary partition 58a performs switching between the non-communicating state in which the entrance-side gas replacement chamber 36 and the heat treatment chamber 30 do not communicate and the communicating state in which the entrance-side gas replacement chamber 36 and the heat treatment chamber 30 communicate.

As illustrated in FIG. 1, the posture adjusting device 60 is located in the posture adjusting part 20. The posture adjusting device 60 comprises a plurality of (two in this example) posture adjusting bodies 80 and actuators 82.

The posture adjusting bodies 80 are located in the posture adjusting chamber 40. The two posture adjusting bodes 80 are arranged next to each other in the left-right direction. The actuators 82 are located outside of the posture adjusting chamber 40 (the furnace body 12). Therefore, even when wear dust is generated from operation parts or sliding parts of the actuators 82 by the operation of the actuators 82, the wear dust can be suppressed from entering the posture adjusting chamber 40. For example, when fluid pressure cylinders are used as the actuators 82, the cylinders are arranged outside of the furnace body 12, and the ends of the piston rods to be driven are connected to the posture adjusting bodies 80 in the furnace body 12. With this arrangement, the cylinders and sliding parts of the piston rods are positioned outside of the furnace body 12 and wear dust generated from the sliding parts is suppressed from entering the posture adjusting chamber 40. The actuator 82 moves the posture adjusting bodies 80 in the up-down direction. The posture adjusting bodies 80 switch their position between an adjusting position and a non-adjusting position by the operation of the actuators 82. When the posture adjusting bodies 80 are in the adjusting position, the upper ends of the posture adjusting bodies 80 are positioned above the rollers 14. In this state, the posture adjusting bodies 80 are in contact with the saggars 4 moving in the conveying direction DI. When the saggars 4 come into contact with the posture adjusting bodies 80, the postures of the saggars 4 are adjusted to predetermined postures. When the posture adjusting bodies 80 are in the non-adjusting position, the upper ends of the posture adjusting bodies 80 are positioned below the rollers 14. In this state, the saggars 4 are not in contact with the posture adjusting bodies 80.

The stopper device 62 is provided in the unstacking part 22. The stopper device 62 comprises a plurality of (two in this embodiment) stoppers 84 and actuators 86.

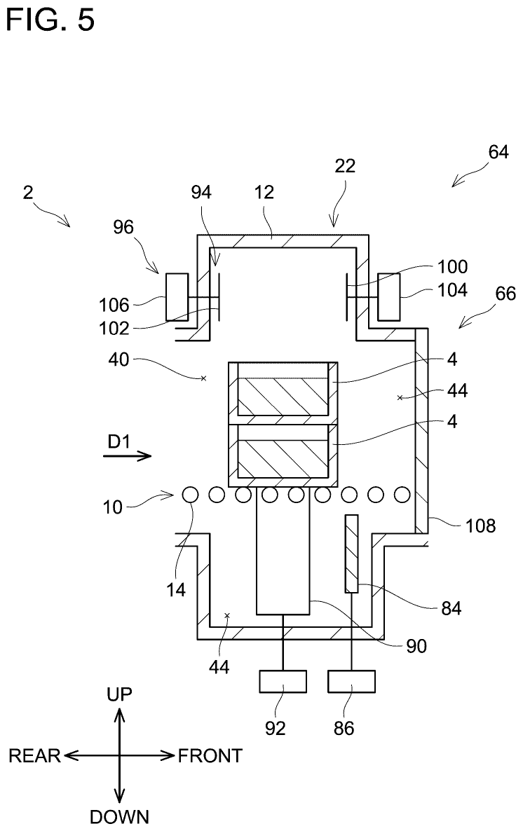

The stoppers 84 are located in the unstacking chamber 44. The two stoppers 84 are arranged next to each other in the left-right direction. The actuators 86 are located outside of the unstacking chamber 44 (the furnace body 12). Therefore, even when wear dust is generated from the actuators 86 by the operation of the actuators 86, the wear dust can be suppressed from entering the unstacking chamber 44. The actuators 86 move the stoppers 84 in the up-down direction. The stoppers 84 switch their positions between a stopping position and a non-stopping position by the operation of the actuators 86. When stoppers 84 are in the stopping position, the upper ends of stoppers 84 are positioned above the rollers 14. In this state, the stoppers 84 are in contact with the saggars 4 moving in the conveying direction D1. Consequently, the saggars 4 stop. As illustrated in FIG. 5, when the stoppers 84 are in the non-stopping position, the upper ends of the stoppers 84 are positioned below the rollers 14.

The unstacking device 64 is located in the unstacking part 22. The unstacking device 64 comprises a lifting device body 90, a lifting actuator 92, a clamping device body 94, and a clamping actuator 96.

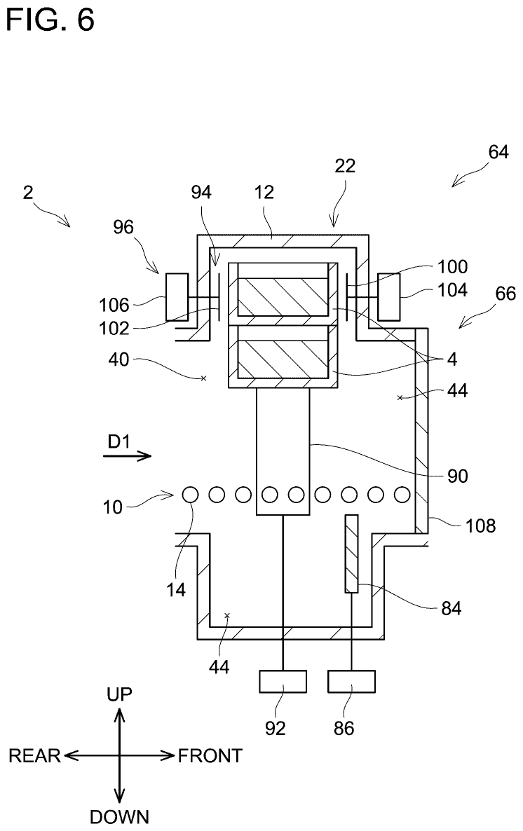

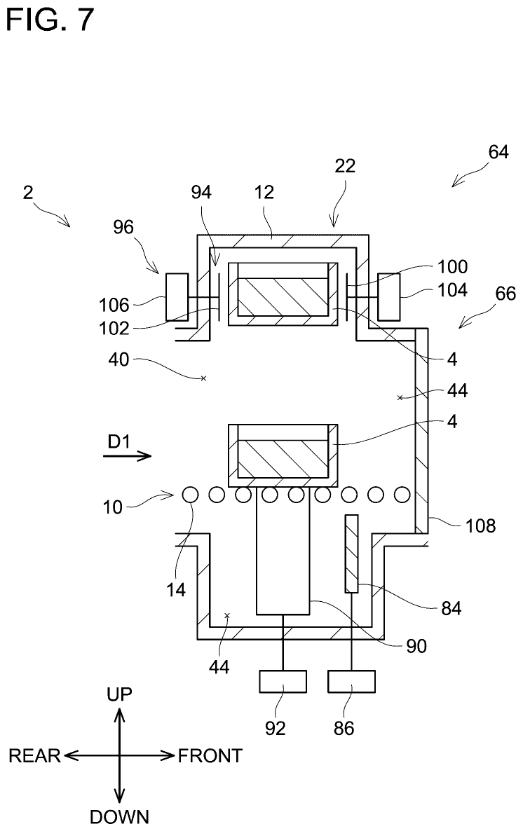

The lifting device body 90 is located in the unstacking chamber 44. The lifting device body 90 is located upstream of the stoppers 84 in the conveying direction D1. The lifting actuator 92 is provided outside of the unstacking chamber 44 (the furnace body 12). Therefore, even when wear dust is generated from the lifting actuator 92 by the operation of the lifting actuator 92, the wear dust can be suppressed from entering the unstacking chamber 44. The lifting actuator 92 moves the lifting device body 90 in the up-down direction. As illustrated in FIG. 6, when the lifting device body 90 moves to a position above the rollers 14, the plurality of saggars 4 which is in contact with the stoppers 84 are placed on the lifting device body 90 in a stacked state and lifted. As illustrated in FIG. 7, when the lifting device body 90 moves to a position below the rollers 14, the saggars 4 placed on the lifting device body 90 are lowered and placed on the rollers 14.

The clamping device body 94 is located in the unstacking chamber 44. The clamping device body 94 comprises a first clamp 100 and a second clamp 102. The first clamp 100 and the second clamp 102 are disposed at an upper portion of the unstacking part 22. The first clamp 100 and the second clamp 102 face each other in the front-rear direction.

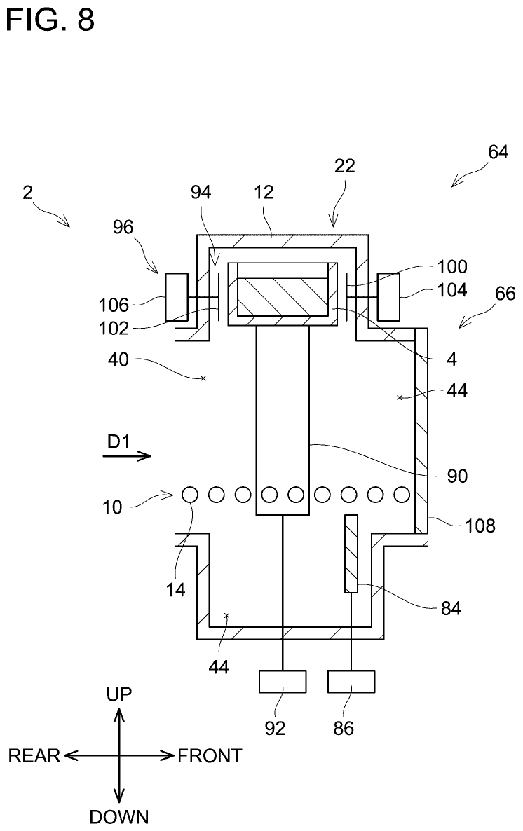

Clamping actuators 96 are located outside of the unstacking chamber 44 (the furnace body 12). Therefore, even when wear dust is generated from the clamping actuators 96 by the operation of the clamping actuators 96, the wear dust can be suppressed from entering the unstacking chamber 44. The clamping actuators 96 comprise a first clamping actuator 104 and a second clamping actuator 106. The first clamping actuator 104 operates the first clamp 100 and the second clamping actuator 106 operates the second clamp 102. Consequently, the first clamp 100 and the second clamp 102 move in the front-rear direction to approach each other and move in the front-rear direction to separate away from each other. When the first clamp 100 and the second clamp 102 move to approach each other while the plurality of stacked saggars 4 is lifted by the lifting device body 90, the upper saggars 4 are clamped by the first clamp 100 and the second clamp 102. As illustrated in FIG. 8, when the first clamp 100 and the second clamp 102 move to separate away from each other, the upper saggars 4 are released from the first clamp 100 and the second clamp 102.

As illustrated in FIG. 1, the first partition device 66 comprises a first partition 108 and a first actuator 110.

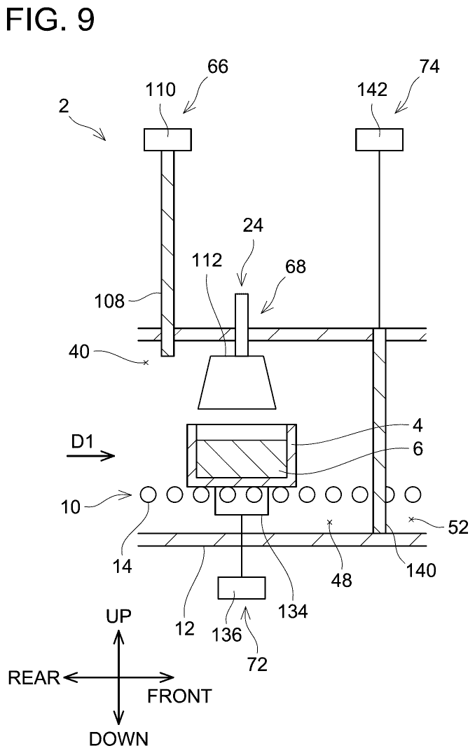

The first partition 108 is located inside the furnace body 12. The first partition 108 is disposed between (at the boundary of) the unstacking chamber 44 and the suction chamber 48. The first actuator 110 is disposed outside of the furnace body 12. Therefore, even when wear dust is generated from the first actuator 110 by the operation of the first actuator 110, the wear dust can be suppressed from entering the unstacking chamber 44 and the suction chamber 48. The first actuator 110 operates the first partition 108. The first partition 108 switches its position between a non-communicating position and a communicating position by the operation of the first actuator 110. When the first partition 108 is in the non-communicating position, it blocks the communication between the unstacking chamber 44 and the suction chamber 48. In this state, the suction chamber 48 and the heat treatment chamber 30 do not communicate via the unstacking chamber 44 and the posture adjusting chamber 40. As illustrated in FIG. 9, when the first partition 108 is in the communicating position, the lower end of the first partition 108 is positioned above the upper end of the upper saggar 4 on the rollers 14. In this state, the unstacking chamber 44 and the suction chamber 48 communicate. Therefore, the suction chamber 48 and the heat treatment chamber 30 communicate through the unstacking chamber 44 and the posture adjusting chamber 40. Therefore, by switching its position between the non-communicating position and the communicating position, the first partition 108 performs switching between the non-communicating state in which the heat treatment chamber 30 and the suction chamber 48 do not communicate and the communicating state in which the heat treatment chamber 30 and the suction chamber 48 communicate.

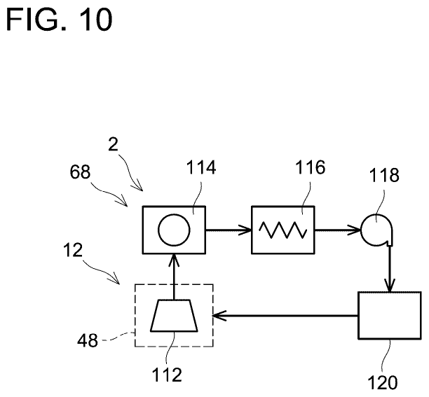

As illustrated in FIG. 10, the suction collection device 68 comprises a plurality of (two in the present embodiment) suction nozzles 112, a baghouse filter 114, a heat exchanger 116, a fan 118, and a filter 120.

As illustrated in FIG. 1, the suction nozzles 112 are located in the suction chamber 48. The suction nozzles 112 are fixed to the suction collection part 24. The suction nozzles 112 are not movable in the front-rear direction, the up-down direction, and the left-right directions. The suction nozzles 112 are positioned above the rollers 14. The suction nozzles 112 suction gas in the suction chamber 48 by the operation of the fan 118 (see FIG. 10). Consequently, when the suction nozzles 112 are positioned directly above the saggars 4, the objects 6 in the saggars 4 are suctioned into the suction nozzles 112 together with the gas.

As illustrated in FIG. 10, the baghouse filter 114, the heat exchanger 116, the fan 118, and the filter 120 are located outside of the furnace body 12. The baghouse filter 114 is connected to the suction nozzles 112. The baghouse filter 114 captures the objects 6 (see FIG. 1) that are suctioned into the suction nozzle 112. Consequently, the objects 6 are collected.

The heat exchanger 116 is connected to the baghouse filter 114. Coolant flows in the heat exchanger 116, thus the heat exchanger 116 cools the gas that has passed through the baghouse filter 114.

The fan 118 is connected to the heat exchanger 116. The fan 118 generates gas flow in the suction collection device 68. The fan 118 suctions the gas into the filter 120.

The filter 120 is located between the fan 118 and the suction chamber 48. The filter 120 removes foreign matter from the gas discharged from the fan 118. Consequently, gas that is free of foreign matter is sent to the suction chamber 48.

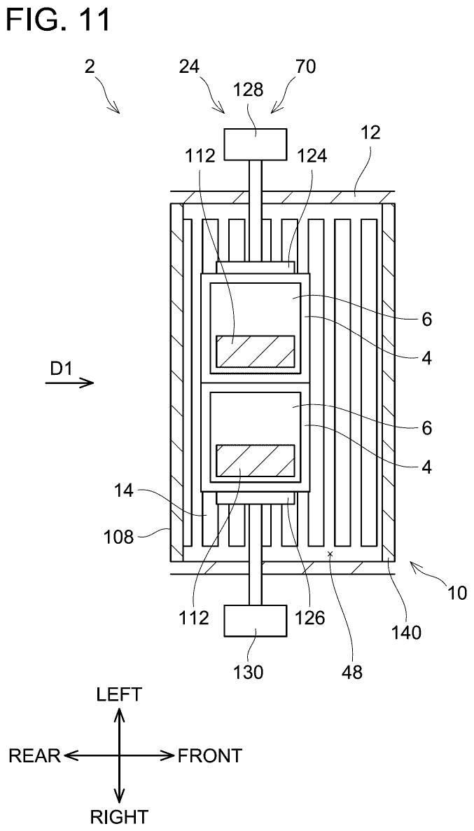

As illustrated in FIG. 11, the saggar moving device 70 comprises a first moving device body 124, a second moving device body 126, a first moving actuator 128, and a second moving actuator 130.

The first moving device body 124 and the second moving device body 126 are located in the suction chamber 48. The first moving device body 124 and the second moving device body 126 face each other in the left-right direction. The first moving device body 124 is positioned to the left of the saggars 4. The second moving device body 126 is positioned to the right of the saggars 4.

The first moving actuator 128 and the second moving actuator 130 are located outside the suction chamber 48 (furnace body 12). Therefore, even when wear dust is generated from the first moving actuator 128 and the second moving actuator 130 due to the operation of the first moving actuator 128 and the second moving actuator 130, the wear dust is suppressed from entering the suction chamber 48. The first moving actuator 128 moves the first moving device body 124 in the left-right direction. The second moving actuator 130 moves the second moving device body 126 in the left-right direction. As the first moving device body 124 and the second moving device body 126 move in the left-right direction, the saggars 4 move in the left-right direction with respect to the suction nozzle 112.

As illustrated in FIG. 9, the lifting device 72 is located in the suction collection part 24. The lifting device 72 comprises a lifting device body 134 and a lifting actuator 136.

The lifting device body 134 is located in the suction chamber 48. The lifting device body 134 is located directly below the suction nozzles 112. The lifting actuator 136 is located outside of the suction chamber 48 (furnace body 12). Therefore, even when wear dust is generated from the lifting actuator 136 due to the operation of the lifting actuator 136, the wear dust is suppressed from entering the suction chamber 48. The lifting actuator 136 moves the lifting device body 134 in the up-down direction. As illustrated in FIG. 1, when the lifting device body 134 moves to a position above the rollers 14, the saggars 4 are placed on the lifting device body 134 and lifted. As illustrated in FIG. 9, when the lifting device body 134 moves to a position below the rollers 14, the saggars 4 are lowered and placed on the rollers 14.

The second partition device 74 comprises a second partition 140 and a second actuator 142.

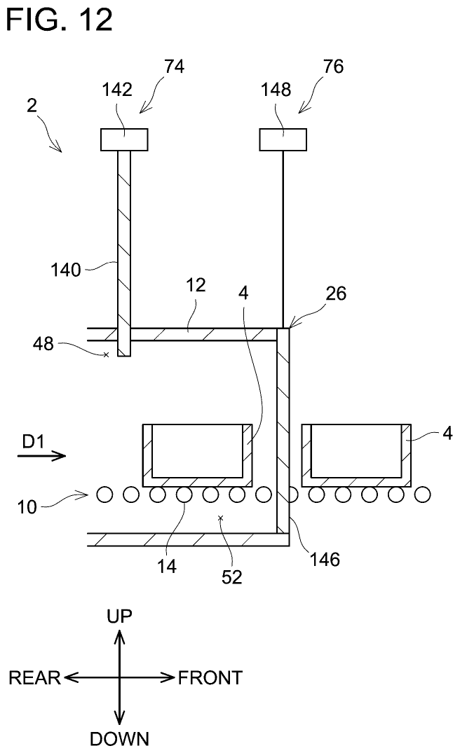

The second partition 140 is located inside the furnace body 12. The second partition 140 is disposed between (at the boundary of) the suction chamber 48 and the exit-side gas replacement chamber 52. The second actuator 142 is disposed outside of the furnace body 12. Therefore, even when wear dust is generated from the second actuator 142 by the operation of the second actuator 142, the wear dust can be suppressed from entering the suction chamber 48 and the exit-side gas replacement chamber 52. The second actuator 142 operates the second partition 140. The second partition 140 switches its position between a non-communicating position and a communicating position by the operation of the second actuator 142. When the second partition 140 is in the non-communicating position, it blocks the communication between the suction chamber 48 and the exit-side gas replacement chamber 52. In this state, the exit-side gas replacement chamber 52 and the suction chamber 48 do not communicate. As illustrated in FIG. 12, when the second partition 140 is in the communicating position, the lower end of the second partition 140 is positioned above the upper end of the upper saggar 4 on the rollers 14. In this state, the suction chamber 48 and the exit-side gas replacement chamber 52 communicate. Therefore, by switching its position between the non-communicating position and the communicating position, the second partition 140 performs switching between the non-communicating state in which the suction chamber 48 and the exit-side gas replacement chamber 52 do not communicate and the communicating state in which the suction chamber 48 and the exit-side gas replacement chamber 52 communicate. A hermeticity between the suction chamber 48 and the exit-side gas replacement chamber 52 achieved by the second partition 140 is higher than a hermeticity between the unstacking chamber 44 and the suction chamber 48 achieved by the first partition 108 (see FIG. 9).

The third partition device 76 comprises a third partition 146 and a third actuator 148.

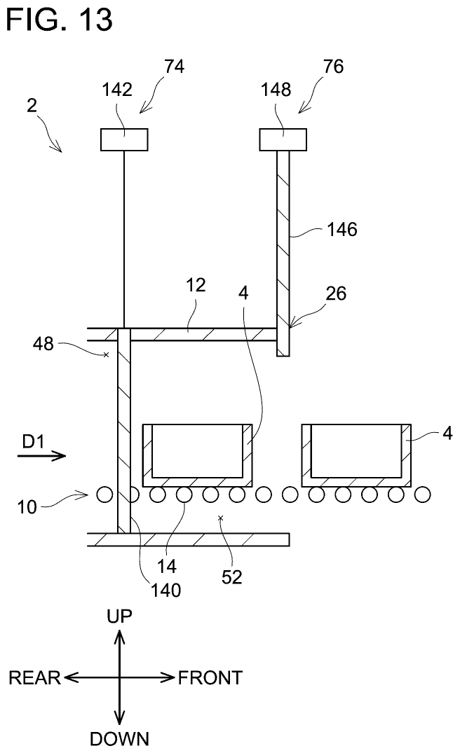

The third partition 146 is disposed between (at the boundary of) the exit-side gas replacement chamber 52 and the space outside of the furnace body 12. The third actuator 148 is disposed outside of the furnace body 12. Therefore, even when wear dust is generated from the third actuator 148 by the operation of the third actuator 148, the wear dust can be suppressed from entering the exit-side gas replacement chamber 52. The third actuator 148 operates the third partition 146. The third partition 146 switches its position between a non-communicating position and a communicating position by the operation of the third actuator 148. When the third partition 146 is in the non-communicating position, it blocks the communication between the exit-side gas replacement chamber 52 and the space outside of the furnace body 12. In this state, the exit-side gas replacement chamber 52 and the space outside of the furnace body 12 do not communicate. As illustrated in FIG. 13, when the third partition 146 is in the communicating position, the lower end of the third partition 146 is positioned above the upper end of the upper saggar 4 on the rollers 14. In this state, the exit-side gas replacement chamber 52 and the space outside of the furnace body 12 communicate. Therefore, by switching its position between the non-communicating position and the communicating position, the third partition 146 performs switching between the non-communicating state in which the exit-side gas replacement chamber 52 and the space outside of the furnace body 12 do not communicate and the communicating state in which the exit-side gas replacement chamber 52 and the space outside of the furnace body 12 communicate. When the second partition 140 is in the non-communicating position, the third partition 146 switches its position from the non-communicating position to the communicating position. A hermeticity between the exit-side gas replacement chamber 52 and the space outside of the furnace body 12 achieved by the third partition 146 is substantially identical to a hermeticity between the suction chamber 48 and the exit-side gas replacement chamber 52 achieved by the second partition 140.

A flow of conveyance of the saggars 4 is described below. First, as illustrated in FIG. 3, when the secondary partition 58a is in the non-communicating position, the primary partition 56a moves from the non-communicating position to the communicating position. Next, the plurality of saggars 4 is conveyed into the entrance-side gas replacement chamber 36 from outside the furnace body 12 by rotation of the rollers 14, with the stacks of saggars 4 arranged next to each other in the left-right direction. Next, the primary partition 56a moves from the communicating position to the non-communicating position. Next, gas in the entrance-side gas replacement chamber 36 is replaced from air to ambient gas.

Next, as illustrated in FIG. 4, the secondary partition 58a moves from the non-communicating position to the communicating position. Next, the plurality of saggars 4 is conveyed out of the entrance 32 toward the heat treatment chamber 30 by rotation of the rollers 14, with the stacks of saggars 4 arranged next to each other in the left-right direction. The secondary partition 58a then moves from the communicating position to the non-communicating position.

Next, as illustrated in FIG. 1, the plurality of saggars 4 moves from the entrance 32 to the exit 34 in the heat treatment chamber 30 by rotation of the rollers 14, with the stacks of saggars 4 arranged in the left-right direction. Consequently, the objects 6 filled in the saggars 4 are fired, i.e., heat treated. Next, the plurality of saggars 4 is then conveyed out of the exit 34 toward the posture adjusting chamber 40.

Next, the plurality of saggars 4 moves in the posture adjusting chamber 40 in the conveying direction D1 by rotation of the rollers 14 with the stacks of saggars 4 arranged next to each other in the left-right direction. The plurality of saggars 4 then comes into contact with the posture adjusting bodies 80 which are at the adjusting position. As a result, the postures of the plurality of saggars 4 are adjusted to predetermined postures. Next, the posture adjusting bodies 80 move from the adjusting position to the non-adjusting position. As a result, the plurality of saggars 4 is conveyed out of the posture adjusting chamber 40 toward the unstacking chamber 44. By controlling a timing at which the position of the posture adjusting bodies 80 is switched, the plurality of saggars 4 is conveyed out of the posture adjusting chamber 40 toward the unstacking chamber 44 at a predetermined time interval.

Next, the plurality of saggars 4 moves in the conveying direction D1 in the unstacking chamber 44 by rotation of the rollers 14 with the stacks of saggars 4 arranged next to each other in the left-right direction and stacked. Next, the plurality of saggars 4 comes into contact with the stoppers 84 at the stopping position. Consequently, the plurality of saggars 4 stops. Next, as illustrated in FIG. 5, the stoppers 84 move from the stopping position to the non-stopping position.

Next, as illustrated in FIG. 6, the lifting device body 90 move upward to a position above the rollers 14. As a result, the plurality of saggars 4 is placed on the lifting device body 90 with the saggars 4 arranged side by side in stacks in the left-right direction, and is lifted. Next, as illustrated in FIG. 7, the first clamp 100 and the second clamp 102 move to approach each other. As a result, the plurality of upper saggars 4 is clamped by the first clamp 100 and the second clamp 102. On the other hand, the plurality of lower saggars 4 is not clamped by the first clamp 100 and the second clamp 102. Next, the lifting device body 90 is lowered to a position below the rollers 14. As a result, the plurality of lower saggars 4 is placed on the rollers 14 with the saggars 4 arranged in the left-right direction. Next, the first partition 108 moves from the non-communicating position to the communicating position. Next, the plurality of unstacked saggars 4 is conveyed out of the unstacking chamber 44 toward the suction chamber 48 by the rotation of the rollers 14. As described above, the plurality of saggars 4 is unstacked from the stacked state, and first, the lower saggars 4 are conveyed toward the suction chamber 48. Next, the first partition 108 moves from the communicating position to the non-communicating position.

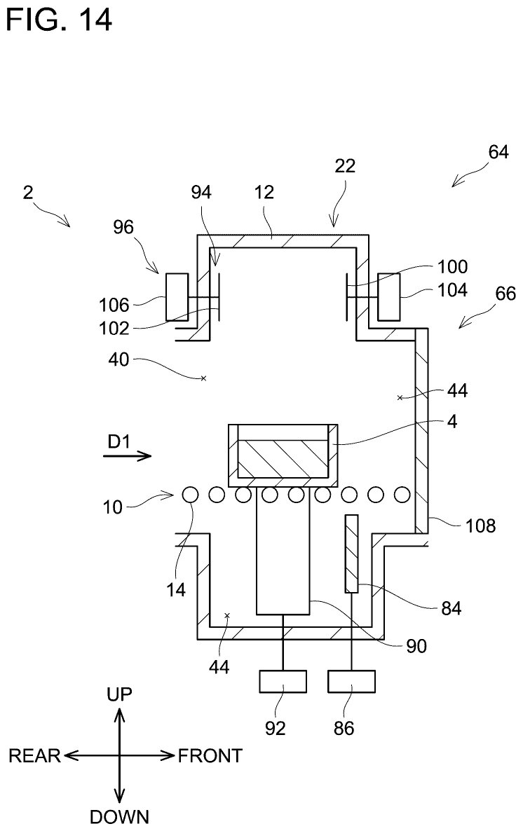

Next, as illustrated in FIG. 8, the lifting device body 90 moves upward to the plurality of saggars 4 clamped by the first clamp 100 and the second clamp 102. Next, the first clamp 100 and the second clamp 102 move to separate away from each other. As a result, the plurality of saggars 4 is placed on the lifting device body 90. Next, as illustrated in FIG. 14, the lifting device body 90 is lowered to a position below the rollers 14. As a result, the plurality of upper saggars 4 that has been unstacked is placed on the rollers 14 with the saggars 4 arranged in the left-right direction. The first partition 108 then moves from the non-communicating position to the communicating position while the second partition 140 (see FIG. 1) is in the non-communicating position. The plurality of saggars 4 is then conveyed out of the unstacking chamber 44 toward the suction chamber 48 by rotation of the rollers 14. The first partition 108 then moves from the communicating position to the non-communicating position.

Next, as illustrated in FIG. 1, the plurality of saggars 4 moves in the suction chamber 48 in the conveying direction D1 by rotation of the rollers 14, with the saggars 4 arranged in the left-right direction. The plurality of saggars 4 then stops at a position directly below the suction nozzles 112 due to the rollers 14 stopping. Next, the lifting device body 134 moves to a position above the rollers 14. As a result, the plurality of saggars 4 is placed on the lifting device body 134 and is lifted, and the surfaces of the objects 6 in the saggars 4 approach the suction nozzles 112.

Next, as illustrated in FIG. 10, the fan 118 (see FIG. 8) operates. As a result, the suction nozzles 112 suction and collect the objects 6 in the saggars 4 along with the gas in the suction chamber 48. While the suction nozzles 112 are suctioning the objects 6, the first partition 108 is in the non-communicating position. Therefore, the suction chamber 48 and the heat treatment chamber 30 (see FIG. 1) do not communicate. Depressurization in the heat treatment chamber 30 is suppressed, by which the gas (gas flow) disturbance in the heat treatment chamber 30 is suppressed.

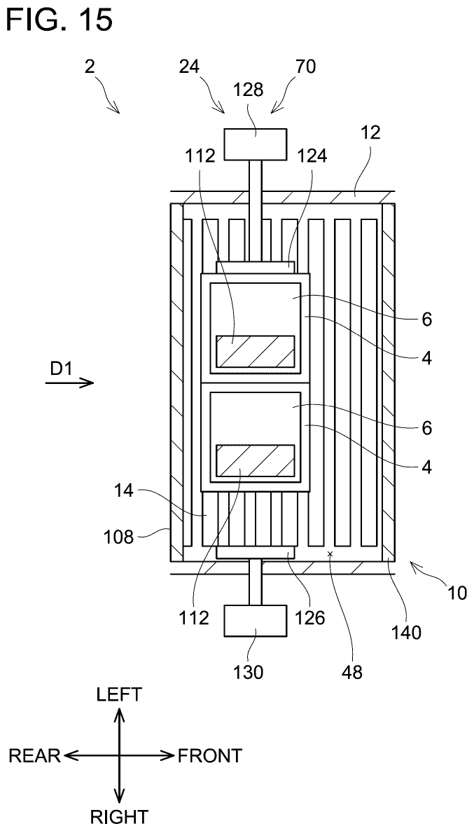

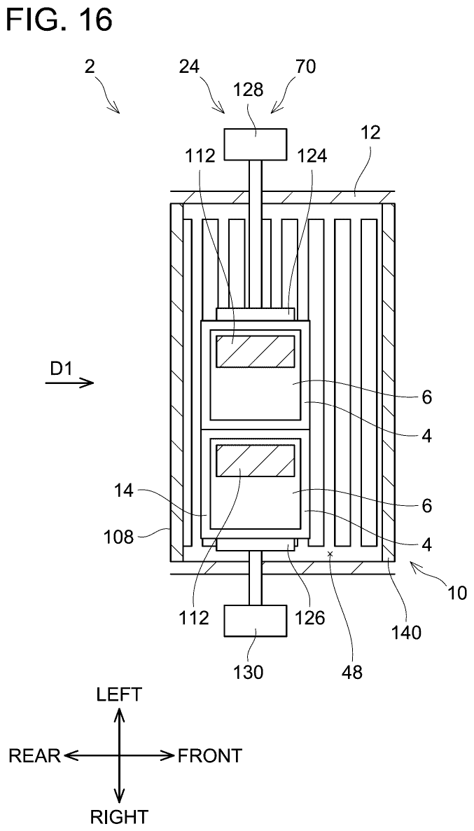

While the suction nozzles 112 are suctioning the objects 6, the saggar moving device 70 and the lifting device 72 operate. Specifically, as illustrated in FIG. 15, the first moving device body 124 moves in the rightward direction until it comes into contact with the saggar 4, and the second moving device body 126 moves in the rightward direction. Next, as illustrated in FIG. 16, the first moving device body 124 moves in the rightward direction. As a result, the saggars 4 move in the rightward direction and come into contact with the second moving device body 126. As a result, relative positions of the suction nozzles 112 with respect to the saggars 4 move in the leftward direction. As a result, the surface layers of the objects 6 in the saggars 4 are suctioned by the suction nozzles 112. Next, the lifting device body 134 slightly moves upward. As a result, the surfaces of the objects 6 in the saggars 4 approach the suction nozzles 112.

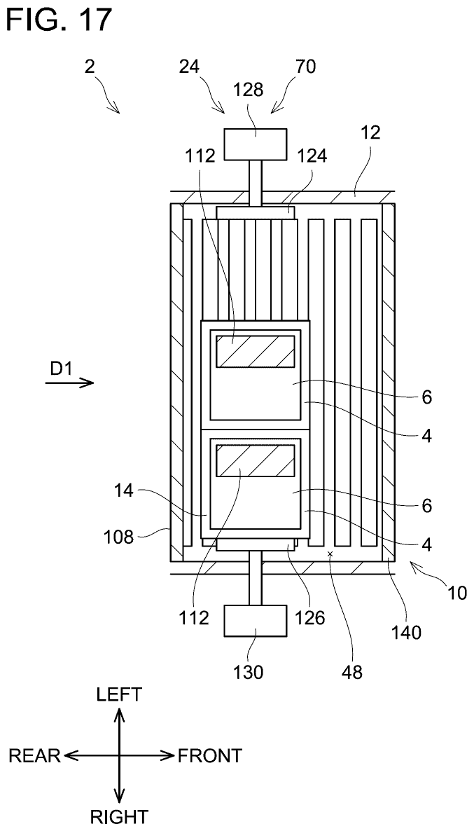

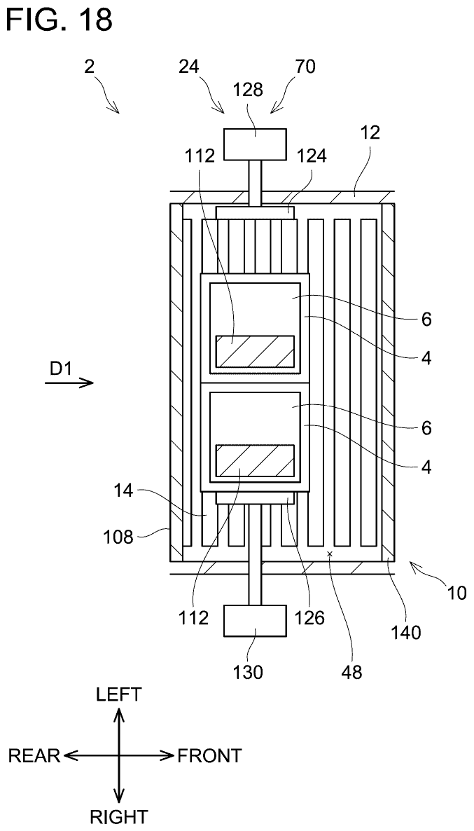

Next, as illustrated in FIG. 17, the first moving device body 124 moves in the leftward direction. Next, as illustrated in FIG. 18, the second moving device body 126 moves in the leftward direction. As a result, the saggars 4 move in the leftward direction and come into contact with the first moving device body 124. As a result, relative positions of the suction nozzles 112 with respect to the saggars 4 move in the rightward direction. As a result, the surface layers of the objects 6 in the saggars 4 are suctioned by the suction nozzles 112. Next, the lifting device body 134 slightly moves upward. As a result, the surfaces of the objects 6 in the saggars 4 approaches the suction nozzles 112. By repeating the operations of the saggar moving device 70 and the lifting device 72 described above, all of the objects 6 in the saggars 4 are suctioned into the suction nozzles 112.

Next, the lifting device body 134 (see FIG. 9) moves to a position below the rollers 14. As a result, the plurality of saggars 4 is placed on the rollers 14. Next, as illustrated in FIG. 12, the second partition 140 moves from the non-communicating position to the communicating position while the third partition 146 is in the non-communicating position. The plurality of saggars 4 is then conveyed out of the suction chamber 48 toward the exit-side gas replacement chamber 52 by rotation of the rollers 14 with the saggars 4 arranged in the left-right direction. Next, the second partition 140 moves from the communicating position to the non-communicating position. Next, the gas in the exit-side gas replacement chamber 52 is replaced from ambient gas to air.

Next, as illustrated in FIG. 13, the third partition 146 moves from the non-communicating position to the communicating position. The plurality of saggars 4 is then conveyed out of the exit-side gas replacement chamber 52 toward the outside of the furnace body 12 by the rotation of the rollers 14, with the saggars 4 arranged in the left-right direction. Next, the third partition 146 moves from the communicating position to the non-communicating position. Next, the gas in the exit-side gas replacement chamber 52 is replaced from air to ambient gas.

### (Effects)

In the above embodiment, while the suction nozzles 112 are suctioning the objects 6, the first partition 108 is in the non-communicating position. Therefore, the suction chamber 48 and the heat treatment chamber 30 (see FIG. 1) do not communicate. Consequently, depressurization in the heat treatment chamber 30 can be suppressed. As a result, gas flow disturbance in the heat treatment chamber 30 can be suppressed.

### (Corresponding Relationships)

The exit-side gas replacement chamber 52 is an example of “gas replacement chamber”.

### (Variants)

The furnace body 12 of one embodiment may not comprise at least one of the posture adjusting part 20 and the unstacking part 22.

The suction nozzles 112 of one embodiment may be movable in the left-right direction. In this configuration, the suction nozzles 112 move in the left-right direction to suction and collect the objects 6 in the saggars 4. The suction collection system 2 may not include the saggar moving device 70.

In the suction collection system 2 of one embodiment, the plurality of saggars 4 may be conveyed into the heat treatment chamber 30 from the entrance 32 with the saggars 4 not stacked in the up-down direction (i.e., with only a single layer of saggar in the up-down direction).

In the suction collection system 2 of one embodiment, the plurality of saggars 4 may be conveyed into the heat treatment chamber 30 from entrance 32, with the saggars 4 not arranged in the left-right direction (i.e., in only a single row in the conveying direction D1).

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A suction collection system comprising:
a conveying device configured to convey saggars in a conveying direction;
a heat treatment chamber including an entrance and an exit and inside which the saggars are conveyed from the entrance toward the exit;
a suction chamber disposed downstream of the exit and through which the saggars conveyed out of the exit move;
a suction nozzle disposed in the suction chamber and configured to suction and collect an object in each of the saggars;
a first partition disposed between the heat treatment chamber and the suction chamber and configured to perform switching between a communicating state in which the heat treatment chamber and the suction chamber communicate and a non-communicating state in which the heat treatment chamber and the suction chamber do not communicate;
a gas replacement chamber disposed downstream of the suction chamber and through which the saggars conveyed out of the suction chamber move; and
a second partition disposed between the suction chamber and the gas replacement chamber and configured to perform switching between a communicating state in which the suction chamber and the gas replacement chamber communicate and a non-communicating state in which the suction chamber and the gas replacement chamber do not communicate.

2. The suction collection system according to claim 1, further comprising:
a posture adjusting chamber disposed between the heat treatment chamber and the suction chamber and through which the saggars conveyed out of the exit move; and
a posture adjusting device configured to adjust postures of the saggars in the posture adjusting chamber,
wherein
the first partition is disposed between the posture adjusting chamber and the suction chamber.

3. The suction collection system according to claim 2, wherein
the conveying device is configured to convey the saggars in the conveying direction in a state where the saggars are stacked, and
the suction collection system further comprises:
an unstacking chamber disposed between the posture adjusting chamber and the suction chamber and through which the saggars conveyed out of the posture adjusting chamber move; and
an unstacking device configured to unstack the stacked saggars so that the saggars are not stacked in the posture adjusting chamber.

4. The suction collection system according to claim 3, wherein
the unstacking device comprises:
a clamping device body configured to clamp the saggar; and
a clamping actuator configured to operate the clamping device body,
wherein
the clamping actuator is disposed outside of the unstacking chamber.

5. The suction collection system according to claim 3, wherein
the unstacking device comprises:
a lifting device body configured to lift the stacked saggars;
a lifting actuator configured to operate the lifting device body; and
a clamping device body configured to clamp one of the stacked saggars lifted by the lifting device body,
wherein
the lifting actuator is disposed outside of the unstacking chamber.

6. The suction collection system according to claim 3, wherein the first partition is disposed between the unstacking chamber and the suction chamber.

7. The suction collection system according to claim 1, wherein
the suction nozzle is configured not to move in a left-right direction perpendicular to the conveying direction, and
the suction collection system further comprises a saggar moving device configured to move each of the saggars in the left-right direction relative to the suction nozzle when the suction nozzle collects the object in each of the saggars.

8. The suction collection system according to claim 7, further comprising a lifting device configured to lift the saggar in the suction chamber,
wherein
the saggar moving device is configured to move the saggar in the left-right direction relative to the suction nozzle in a state where the saggar is lifted by the lifting device.

9. The suction collection system according to claim 1, further comprising a first actuator disposed outside of the suction chamber and configured to operate the first partition.

10. The suction collection system according to claim 1, further comprising a second actuator disposed outside of the gas replacement chamber and configured to operate the second partition.
